(19) United States
(12) Patent Application Publication
(10) Pub. No.: US 2026/0171626 A1
(43) Pub. Date: Jun. 18, 2026

(54) ELECTRODE ASSEMBLY, ELECTROCHEMICAL DEVICE, AND ELECTRICAL DEVICE

(71) Applicant: Ningde Amperex Technology Limited, Ningde (CN)

(72) Inventors: Yunhao FENG, Ningde (CN); Hua WU, Ningde (CN)

(73) Assignee: Ningde Amperex Technology Limited, Ningde (CN)

(21) Appl. No.: 19/417,358

(22) Filed: Dec. 12, 2025

(30) Foreign Application Priority Data
Dec. 13, 2024 (CN) 202411844457.0

(51) Int. Cl. H01M 50/536; H01M 10/04; H01M 50/586

(52) U.S. Cl. CPC H01M 50/536; H01M 10/0431; H01M 50/586

(57) ABSTRACT

An electrode assembly includes a first electrode plate and a second electrode plate of opposite polarities. A first current collector includes a first conductive layer, a first insulation layer, and a second conductive layer. A first active material layer is provided with a first groove. A first surface is exposed in the first groove. A second surface is covered by a second active material layer. The second active material layer is provided with a second groove. The first surface is covered by the first active material layer. The second surface is exposed in the second groove. A first tab is at least partially accommodated in the first groove, and is bonded to the first single-side blank foil region by a first adhesive layer. A second tab is at least partially accommodated in the second groove, and is bonded to the second single-side blank foil region by a second adhesive layer.

### CROSS-REFERENCE TO RELATED APPLICATION

This application claims priority to the Chinese Patent Application Serial No. 202411844457.0, filed on Dec. 13, 2024, the content of which is incorporated herein by reference in its entirety.

### TECHNICAL FIELD

This application relates to the technical field of electrochemical devices, and in particular, to an electrode assembly, an electrochemical device, and an electrical device.

### BACKGROUND

With the development of electronic information technology, various electronic devices are evolving toward intelligence and versatility, thereby placing increasingly higher requirements on the energy density of electrochemical devices.

An existing composite current collector is a three-layer structure, with an insulation layer in the middle, flanked with conductive layers. With the insulation layer in the middle, the composite current collector cannot be directly welded to a tab, but needs to be welded to the tab through a conductive layer. The high temperature generated by the welding melts the insulation layer to implement conduction between the conductive layers on both sides. However, the conductive layers of the composite current collector are relatively thin, are much prone to form over-welding. The weld is prone to crack, posing a safety risk. Furthermore, the insulation layer encounters the problem of melting insufficiency during the melting, resulting in a lack of electrical contact between the conductive layers on both sides, and weakening the current-carrying capacity of the electrode plate.

### SUMMARY

This application provides an electrode assembly, an electrochemical device, and an electrical device to solve at least one of the above technical problems.

This application is implemented through the following technical solutions:

According to a first aspect, this application provides an electrode assembly. The electrode assembly includes a first electrode plate and a second electrode plate of opposite polarities. The first electrode plate includes a first current collector, a first active material layer, a second active material layer, a first tab, and a second tab. The first current collector includes a first conductive layer, a first insulation layer, and a second conductive layer, the first conductive layer, the first insulation layer, and the second conductive layer are sequentially arranged along a thickness direction of the current collector. The first conductive layer includes a first surface facing away from the first insulation layer. The second conductive layer includes a second surface facing away from the first insulation layer. A first active material layer is disposed on the first surface, and a second active material layer is disposed on the second surface. The first current collector includes a first single-side blank foil region and a second single-side blank foil region. The first active material layer is provided with a first groove. A first surface in the first single-side blank foil region is exposed in the first groove. A second surface in the first single-side blank foil region is covered by the second active material layer. The second active material layer is provided with a second groove. The first surface in the second single-side blank foil region is covered by the first active material layer. The second surface in the second single-side blank foil region is exposed in the second groove. The first tab is at least partially accommodated in the first groove, and is bonded to the first single-side blank foil region by a first adhesive layer. The first tab is electrically connected to the first conductive layer. The second tab is at least partially accommodated in the second groove, and is bonded to the second single-side blank foil region by a second adhesive layer. The second tab is electrically connected to the second conductive layer.

In the above technical solution, the first electrode plate and the second electrode plate are of opposite polarities, so that metal ions can move between the first electrode plate and the second electrode plate to implement charging and discharging of the electrode assembly. The first current collector includes a first conductive layer, a first insulation layer, and a second conductive layer, the first conductive layer, the first insulation layer, and the second conductive layer are sequentially arranged along the thickness direction of the current collector. The first active material layer is disposed on the first surface of the first conductive layer. The second active material layer is disposed on the second surface of the second conductive layer. In this way, metal ions can be intercalated or deintercalated in the first active material layer and the second active material layer to implement movement of the metal ions. The first current collector includes a first single-side blank foil region and a second single-side blank foil region. The first surface in the first single-side blank foil region is bonded to the first tab. The second surface in the first single-side blank foil region is covered by the second active material layer. The first surface in the second single-side blank foil region is covered by the first active material layer. The second surface in the second single-side blank foil region is bonded to the second tab. Compared with a circumstance in which grooves are provided on the current collector on both the side connected to the tab and the side facing away from the tab, in this application, the first current collector is coated with the second active material layer on the side facing away from the first tab, and the first current collector is coated with the first active material layer on the side facing away from the second tab, thereby reducing the loss of active material, making the electrode assembly be coated with a relatively large amount of active material layer, and increasing the energy density of the electrochemical device formed by the electrode assembly. At the same time, the first current collector is a composite current collector. The first tab and the second tab are distributed on two sides of the first current collector respectively. The first tab is electrically connected to the first conductive layer. The second tab is electrically connected to the second conductive layer to facilitate output or input of electrical energy. The arrangement of the first tab and the second tab increases the number of tabs, and can improve the charge and discharge rates. The first tab is at least partially accommodated in the first groove, and the second tab is at least partially accommodated in the second groove, thereby not only facilitating connection between the first tab and the first current collector, and between the second tab and the first current collector, but also reducing the overall thickness of the electrode assembly, and increasing the energy density of an electrochemical device equipped with this electrode assembly. The first tab is bonded to the first conductive layer by the first adhesive layer, and the second tab is bonded to the second conductive layer by the second adhesive layer, thereby facilitating operation and reducing the difficulty of manufacturing. By bonding the first tab to the first conductive layer through the first adhesive layer and bonding the second tab to the second conductive layer through the second adhesive layer, this application makes it unnecessary to weld tabs, thereby reducing the safety hazards of the first current collector caused by weld imprint cracking.

In one or more optional embodiments, the electrode assembly is a jelly-roll structure. Along a winding direction of the electrode assembly, a width of the first groove is W1, and along a winding axis direction of the electrode assembly, a length of the first groove is L1, satisfying: 5 mm≤W1≤15 mm, and 5 mm≤L1≤25 mm; and/or, along a winding direction of the electrode assembly, a width of the second groove is W2, and along a winding axis direction of the electrode assembly, a length of the second groove is L2, satisfying: 5 mm≤W2≤15 mm, and 5 mm≤L2≤25 mm.

In the above technical solution, the width W1 of the first groove is made to satisfy 5 mm≤W1≤15 mm along the winding direction of the electrode assembly, and the length L1 of the first groove is made to satisfy 5 mm≤L1≤25 mm along the winding axis direction of the electrode assembly. On the one hand, this provides a relatively large connection area between the first current collector and the first tab, thereby providing a relatively large current-carrying capacity between the first current collector and the first tab. On the other hand, this reduces the volume loss of the first active material layer, thereby increasing the energy density of an electrochemical device equipped with this electrode assembly. Along the winding direction of the electrode assembly, the width W2 of the second groove is made to satisfy 5 mm≤W2≤15 mm. Along the winding axis direction of the electrode assembly, the length L2 of the second groove is made to satisfy 5 mm≤L2≤25 mm. On the one hand, this provides a relatively large connection area between the first current collector and the second tab, thereby providing a relatively large current-carrying capacity between the first current collector and the second tab. On the other hand, this reduces the volume loss of the second active material layer, thereby increasing the energy density of an electrochemical device equipped with this electrode assembly.

In one or more optional embodiments, the electrode assembly is a jelly-roll structure. The first tab includes a first part that overlaps the first current collector. A thickness of the first part is H1, and along a winding direction of the electrode assembly, a width of the first part is W3, and along a winding axis direction of the electrode assembly, a length of the first part is L3, satisfying: 2 mm≤W3≤14 mm, 2 mm≤L3≤24 mm, and 20μm≤H1≤120 μm; and/or the second tab includes a second part that overlaps the first current collector, a thickness of the second part is H2, and along a winding direction of the electrode assembly, a width of the second part is W4, and along a winding axis direction of the electrode assembly, a length of the second part is L4, satisfying: 2 mm≤W4≤14 mm, and 2 mm≤L4≤24 mm, and 20 μm≤H2≤120 μm.

In the above technical solution, the thickness H1 of the first part is made to satisfy 20 μm≤H1≤120 μm. Along the winding direction of the electrode assembly, the width W3 of the first part is made to satisfy 2 mm≤W3≤14 mm. Along the winding axis direction of the electrode assembly, the length L3 of the first part satisfies: 2 mm≤L3≤24 mm. On the one hand, this provides a relatively large connection area between the first tab and the first current collector, thereby providing a relatively large current-carrying capacity between the first tab and the first current collector. On the other hand, this enables a relatively small area of the first groove, and reduces the volume loss of the first active material layer, thereby increasing the energy density of an electrochemical device equipped with this electrode assembly. The thickness H2 of the second part is made to satisfy 20 μm≤H2≤120 μm. Along the winding direction of the electrode assembly, the width W4 of the second part satisfies 2 mm≤W4≤14 mm. Along the winding axis direction of the electrode assembly, the length L4 of the second part is made to satisfy 2 mm≤L4≤24 mm. On the one hand, this provides a relatively large connection area between the second tab and the first current collector, thereby providing a relatively large current-carrying capacity between the second tab and the first current collector. On the other hand, this enables a relatively small area of the second groove, and reduces the volume loss of the second active material layer, thereby increasing the energy density of an electrochemical device equipped with this electrode assembly.

In one or more optional embodiments, the electrode assembly is a jelly-roll structure. The first electrode plate includes a winding start end and a winding termination end. Along a winding direction of the electrode assembly, the first groove is closer to the winding start end than the second groove. Along the winding direction of the electrode assembly, a distance between the first groove and the winding start end is M1, a distance between the second groove and the winding termination end is M2, and a length of the first electrode plate is M3, satisfying 0.25≤M1/M3≤0.35, and 0.25≤M2/M3≤0.35.

In the above technical solution, along the winding direction of the electrode assembly, with the distance between the first groove and the winding start end being M1, the distance between the second groove and the winding termination end being M2, and the length of the first electrode plate being M3, by making the parameter relationships satisfy 0.25≤M1/M3≤0.35 and 0.25≤M2/M3≤0.35, on the one hand, this facilitates processing and manufacturing, and reduces the risk of interference between the first groove and the second groove; on the other hand, this facilitates the flow of current between the first current collector and the first and second tabs, and facilitates the output and input of electrical energy, thereby improving the charging and discharging efficiency.

In one or more optional embodiments, a plurality of first bulges are formed on one side of the first tab, the side facing the first current collector; and at least a part of the plurality of first bulges are in contact with the first conductive layer.

In the above technical solution, the plurality of first bulges disposed can facilitate the positioning of the first tab relative to the first adhesive layer. The first adhesive layer can be accommodated in a region between two adjacent first bulges, so as to improve the bonding effect between the first tab and the first conductive layer. At least a part of the plurality of first bulges are in contact with the first conductive layer, so as to implement electrical connection between the first tab and the first conductive layer.

In one or more optional embodiments, the first electrode plate further includes a first insulation piece and a second insulation piece. The first insulation piece is disposed on one side of the first tab and covers the first tab, the side facing away from the first current collector. The second insulation piece is disposed on one side of the second tab and covers the second tab, the side facing away from the first current collector.

In the above technical solution, the first insulation piece covers the first tab so that the first insulation piece can play a role in insulating the first tab from the second electrode plate, thereby reducing the probability of contact circuiting between the first electrode plate and the second electrode plate. The second insulation piece covers the second tab so that the second insulation piece can play a role in insulating the second tab from the second electrode plate, thereby reducing the probability of contact shorting between the first electrode plate and the second electrode plate. In view of the burrs on the surfaces of the first tab and the second tab, the first insulation piece and the second insulation piece can also isolate the burrs, and make the burrs less prone to contact the second electrode plate and consequently cause a short circuit or damage the second electrode plate.

In one or more optional embodiments, the second electrode plate includes a second current collector, a third active material layer, a fourth active material layer, and a third tab. The second current collector includes a third surface and a fourth surface disposed opposite to each other. The second current collector includes a third single-side blank foil region. The third active material layer is disposed on the third surface. The third active material layer is provided with a third groove. The third surface in the third single-side blank foil region is exposed in the third groove. The fourth active material layer is disposed on the fourth surface. The fourth surface in the third single-side blank foil region is covered by the fourth active material layer. The third tab is at least partially accommodated in the third groove, and is bonded to the third single-side blank foil region by a third adhesive layer. The third tab is electrically connected to the second current collector.

In the above technical solution, the third active material layer is disposed on the third surface, and the fourth active material layer is disposed on the fourth surface, thereby enabling metal ions to be intercalated in and deintercalated out of the third active material layer and the fourth active material layer, thereby enabling movement of the metal ions. The second current collector includes a third single-side blank foil region. The third surface in the third single-side blank foil region is bonded to the third tab. The fourth surface in the third single-side blank foil region is covered by the fourth active material layer. Compared with a circumstance in which grooves are provided on the current collector on both the side connected to the tab and the side facing away from the tab, in this application, the second current collector is coated with the fourth active material layer on the side facing away from the third tab, thereby reducing the loss of active material, making the electrode assembly be coated with a relatively large amount of active material layer, and increasing the energy density of the electrochemical device formed by the electrode assembly. The third tab is at least partially accommodated in the third groove, thereby not only facilitating connection between the third tab and the second current collector, but also reducing the overall thickness of the electrode assembly, and increasing the energy density of the electrochemical device equipped with this electrode assembly. The third tab is bonded to the third single-side blank foil region by the third adhesive layer, thereby facilitating operation and reducing the difficulty of manufacturing.

In one or more optional embodiments, the second current collector includes a third conductive layer, a second insulation layer, and a fourth conductive layer, the third conductive layer, the second insulation layer, and the fourth conductive layer are sequentially arranged along a thickness direction of the current collector. The third surface is a surface of the third conductive layer, the third surface facing away from the second insulation layer. The fourth surface is a surface of the fourth conductive layer, the fourth surface facing away from the second insulation layer. The second current collector further includes a fourth single-side blank foil region. The fourth active material layer is provided with a fourth groove. The third surface in the fourth single-side blank foil region is covered by the third active material layer. The fourth surface in the fourth single-side blank foil region is exposed in the fourth groove. The second electrode plate further includes a fourth tab. The fourth tab is at least partially accommodated in the fourth groove, and is bonded to the fourth single-side blank foil region by a fourth adhesive layer. The third tab is electrically connected to the third conductive layer. The fourth tab is electrically connected to the fourth conductive layer.

In the above technical solution, the second current collector is a composite current collector. The third tab and the fourth tab are distributed on two sides of the first current collector respectively. The third tab is electrically connected to the third conductive layer, and the fourth tab is electrically connected to the fourth conductive layer, thereby facilitating output and input of electrical energy. The third tab and the fourth tab disposed increase the number of tabs, and improve the charge and discharge rates. The fourth tab is at least partially accommodated in the fourth groove, thereby not only facilitating connection between the fourth tab and the second current collector, but also reducing the overall thickness of the electrode assembly, and increasing the energy density of an electrochemical device equipped with this electrode assembly. The fourth tab is bonded to the fourth single-side blank foil region by the fourth adhesive layer, thereby facilitating operation and reducing the difficulty of manufacturing.

In one or more optional embodiments, the second electrode plate further includes a third insulation piece. The third insulation piece is disposed on one side of the third tab and covers the third tab, the side facing away from the second current collector.

In the above technical solution, the third insulation piece covers the third tab so that the third insulation piece can play a role in insulating the third tab from the first electrode plate, thereby reducing the probability of contact circuiting between the second electrode plate and the first electrode plate. In view of the burrs on the surface of the third tab, the third insulation piece can also isolate the burrs, and make the burrs less prone to contact the first electrode plate and consequently cause a short circuit or damage the first electrode plate.

In one or more optional embodiments, the first electrode plate further includes a fourth insulation piece. The fourth insulation piece is disposed on the first active material layer. When viewed along a thickness direction of the first current collector, a projection of the fourth insulation piece covers the third tab.

In the above technical solution, by making the projection of the fourth insulation piece cover the third tab when viewed along the thickness direction of the first current collector, the fourth insulation piece is enabled to isolate the burrs of the third tab, thereby making the burrs less prone to contact the first active material layer and consequently cause a short circuit or damage the first electrode plate.

In one or more optional embodiments, the second electrode plate further includes a fifth insulation piece and a sixth insulation piece. The fifth insulation piece is disposed on the third active material layer. When viewed along a thickness direction of the second current collector, a projection of the fifth insulation piece covers the first tab. The sixth insulation piece is disposed on the fourth active material layer. When viewed along a thickness direction of the second current collector, a projection of the sixth insulation piece covers the second tab.

In the above technical solution, by making the projection of the fifth insulation piece cover the first tab when viewed along the thickness direction of the second current collector, the fifth insulation piece is enabled to isolate the burrs of the first tab, thereby further making the burrs less prone to contact the second active material layer and consequently cause a short circuit or damage the second electrode plate. By making the projection of the sixth insulation piece cover the second tab when viewed along the thickness direction of the second current collector, the sixth insulation piece is enabled to isolate the burrs of the second tab, thereby further making the burrs less prone to contact the second active material layer and consequently cause a short circuit or damage the second electrode plate.

In one or more optional embodiments, the electrode assembly is a jelly-roll structure. Along a winding direction of the electrode assembly, a width of the third groove is W5, and along a winding axis direction of the electrode assembly, a length of the third groove is L5, satisfying: 5 mm≤W5≤15 mm, and 5 mm≤L5≤25 mm; and/or the third tab includes a third part connected to the third single-side blank foil region, a thickness of the third part is H3, and along a winding direction of the electrode assembly, a width of the third part is W6, and along a winding axis direction of the electrode assembly, a length of the third part is L6, satisfying: 2 mm≤W6≤14 mm, and 2 mm≤L6≤24 mm, and 20 μm≤H3≤120 μm.

In the above technical solution, the width W5 of the third groove is made to satisfy 5 mm≤W5≤15 mm along the winding direction of the electrode assembly, and the length L5 of the third groove is made to satisfy 5 mm≤L5≤25 mm along the winding axis direction of the electrode assembly. On the one hand, this provides a relatively large connection area between the second current collector and the third tab, thereby providing a relatively large current-carrying capacity between the second current collector and the third tab. On the other hand, this reduces the volume loss of the third active material layer, thereby increasing the energy density of an electrochemical device equipped with this electrode assembly. The thickness H3 of the third part is made to satisfy 20 μm≤H3≤120 μm. Along the winding direction of the electrode assembly, the width W6 of the third part satisfies 2 mm≤W6≤14 mm. Along the winding axis direction of the electrode assembly, the length L6 of the third part is made to satisfy 2 mm≤L6≤24 mm. On the one hand, this provides a relatively large connection area between the third tab and the second current collector, thereby providing a relatively large current-carrying capacity between the third tab and the second current collector. On the other hand, this enables a relatively small area of the third groove, and reduces the volume loss of the third active material layer, thereby increasing the energy density of an electrochemical device equipped with this electrode assembly.

In one or more optional embodiments, at least one of the first adhesive layer, the second adhesive layer, the third adhesive layer, or the fourth adhesive layer is a conductive adhesive.

In the above embodiment, at least one of the first adhesive layer, the second adhesive layer, the third adhesive layer, or the fourth adhesive layer is a conductive adhesive, thereby implementing electrical connection between the tab and the current collector more favorably, and improving conductivity.

In one or more optional embodiments, thicknesses of the first conductive layer, the second conductive layer, the third conductive layer, and the fourth conductive layer are all 0.2 μm to 3 μm.

In the above technical solution, the thicknesses of the conductive layers are greater than 0.2 μm, so that the conductive layers are of relatively high conductivity. The thicknesses are less than 3 μm, ensuring that the energy density of the battery is not significantly lost. In addition, due to the insulation layer in the middle of the composite current collector, a conductive layer needs to be disposed on the insulation layer by means of vapor deposition, and the thickness needs to be relatively small.

In one or more optional embodiments, the first electrode plate is a positive electrode plate, and the second electrode plate is a negative electrode plate.

In the above technical solution, the first electrode plate is a positive electrode plate, and the first tab and the second tab are positive tabs. Compared with a single positive tab, the two-positive-tab structure of this application can reduce the internal resistance of the electrochemical device, increase the charge and discharge speed, and reduce the temperature rise caused by charging.

According to a second aspect, this application further provides an electrochemical device. The electrochemical device includes the electrode assembly provided in any one of the above embodiments.

According to a third aspect, this application further provides an electrical device. The electrical device includes the electrochemical device provided in the above embodiment. The electrochemical device is configured to provide electrical energy.

Additional aspects and advantages of this application will be partly given in the following description, and a part thereof will become evident in the following description or will be learned in the practice of this application.

### BRIEF DESCRIPTION OF DRAWINGS

To describe technical solutions in embodiments of this application more clearly, the following outlines the drawings to be used in the embodiments. Understandably, the following drawings show merely some embodiments of this application, and therefore, are not intended to limit the scope. A person of ordinary skill in the art may derive other related drawings from the drawings without making any creative efforts.

FIG. 1 is a cross-sectional view of an electrode assembly according to some embodiments of this application;

FIG. 2 is a schematic structural diagram of a first electrode plate according to some embodiments of this application;

FIG. 3 is a schematic assembly diagram of a plurality of first bulges and a first conductive layer according to some embodiments of this application;

FIG. 4 is a cross-sectional view of an electrode assembly according to other embodiments of this application;

FIG. 5 is a cross-sectional view of an electrode assembly according to still other embodiments of this application;

FIG. 6 is a schematic structural diagram of a second electrode plate according to some embodiments of this application; and

FIG. 7 is a cross-sectional view of an electrode assembly according to still other embodiments of this application.

List of reference signs: 1—electrode assembly; 10—first electrode plate; 11—first current collector; 111—first conductive layer; 112—first insulation layer; 113—second conductive layer; 114—first surface; 115—second surface; 116—first single-side blank foil region; 117—second single-side blank foil region; 12—first active material layer; 121—first groove; 13—second active material layer; 131—second groove; 14—first tab; 141—first part; 142—first bulge; 15—second tab; 151—second part; 161—first adhesive layer; 162—second adhesive layer; 171—first insulation piece; 172—second insulation piece; 173—fourth insulation piece; 181—winding start end; 182—winding termination end; 20—second electrode plate; 21—second current collector; 211—third surface; 212—fourth surface; 213—third single-side blank foil region; 214—third conductive layer; 215—second insulation layer; 216—fourth conductive layer; 217—fourth single-side blank foil region; 22—third active material layer; 221—third groove; 23—fourth active material layer; 231—fourth groove; 24—third tab; 241—third part; 25—fourth tab; 251—fourth part; 261—third adhesive layer; 262—fourth adhesive layer; 271—third insulation piece; 272—fifth insulation piece; 273—sixth insulation piece; 274—seventh insulation piece.

### DETAILED DESCRIPTION

To make the objectives, technical solutions, and advantages of some embodiments of this application clearer, the following gives a clear and complete description of the technical solutions in some embodiments of this application with reference to the drawings in some embodiments of this application. Apparently, the described embodiments are merely a part of but not all of the embodiments of this application.

Unless otherwise defined, all technical and scientific terms used herein have the same meanings as what is normally understood by a person skilled in the technical field of this application. The terms used in the specification of this application are merely intended to describe specific embodiments but not intended to limit this application. The terms “include” and “contain” and any variations thereof used in the specification, claims, and brief description of drawings of this application are intended as non-exclusive inclusion. The terms such as “first” and “second” used in the specification, claims, and brief description of drawings herein are intended to distinguish between different items, but are not intended to describe a specific sequence or order of precedence.

Reference to “embodiment” in this application means that a specific feature, structure or characteristic described with reference to the embodiment may be included in at least one embodiment of this application. Reference to this term in different places in the specification does not necessarily represent the same embodiment, nor does it represent an independent or alternative embodiment in a mutually exclusive relationship with other embodiments. A person skilled in the art explicitly and implicitly understands that an embodiment described in this application may be combined with another embodiment.

In the description of this application, unless otherwise expressly specified and defined, the terms “mount”, “concatenate”, “connect”, and “attach” are understood in a broad sense. For example, a “connection” may be a fixed connection, a detachable connection, or an integrated connection; or may be a direct connection or an indirect connection implemented through an intermediary; or may be internal communication between two components. A person of ordinary skill in the art is able to understand the specific meanings of the terms in this application according to specific situations.

As used herein, the term “and/or” indicates merely a relation between related items, and represents three possible relationships. For example, “A and/or B” may represent the following three circumstances: A alone, both A and B, and B alone. In addition, the character “/” herein generally indicates an “or” relationship between the item preceding the character and the item following the character.

“A plurality of” referred to in this application means two or more (including two). Similarly, “a plurality of groups” means two or more groups (including two groups), and “a plurality of pieces” means two or more pieces (including two pieces).

An electrochemical device includes a housing, an electrode assembly, and an electrolyte solution. The housing is configured to accommodate the electrode assembly and the electrolyte solution. The housing may be made of an aluminum shell or an aluminum laminated film. The electrode assembly includes a positive electrode plate, a negative electrode plate, and a separator. The electrochemical device works primarily by shuttling metal ions between the positive electrode plate and the negative electrode plate. The positive electrode plate includes a positive current collector and a positive active material layer. A surface of the positive current collector is coated with the positive active material layer. A part, uncoated with the positive active material layer, of the positive current collector is provided with a positive tab, so that the electrical energy of the positive electrode plate is input or output through the positive tab. Using a lithium-ion battery as an example, the positive current collector may be made of aluminum, and a positive active material may be lithium cobalt oxide, lithium iron phosphate, a ternary material, lithium manganese oxide, or the like. The negative electrode plate includes a negative current collector and a negative active material layer. A surface of the negative current collector is coated with the negative active material layer. A part, uncoated with the negative active material layer, of the negative current collector is provided with a negative tab, so that the electrical energy of the negative electrode plate is input or output through the negative tab. The negative current collector may be made of copper, and the negative active material may be a carbon material, a silicon material, or the like. The separator may be made of polypropylene, polyethylene, or another material. The separator is disposed between the positive electrode plate and the negative electrode plate, and is configured to separate the positive electrode plate from the negative electrode plate but allow passage of metal ions.

With the development of the new energy industry, electrochemical devices are developing a trend toward a high energy density and a high power density. However, currently, a positive electrode plate or a negative electrode plate in an electrode assembly is typically formed of a current collector, two active material layers disposed on two opposite sides of the current collector respectively, and a tab. The active material layer needs to be grooved to accommodate a tab so that the tab is connected to the current collector. However, due to process limitations, in welding the tab to the current collector, two opposite grooves need to be formed on the two active material layers at the same time. The tab is only accommodated in one of the grooves. This results in waste of the groove of the current collector on the side facing away from the tab, and results in loss of active material and a low energy density of the electrochemical device. In addition, an existing composite current collector is a three-layer structure, with an insulation layer in the middle, flanked with conductive layers. With the insulation layer in the middle, the composite current collector cannot be directly welded to a tab, but needs to be welded to the tab through a conductive layer. The high temperature generated by the welding melts the insulation layer to implement conduction between the conductive layers on both sides. However, the conductive layers of the composite current collector are relatively thin, are much prone to form over-welding. The weld is prone to crack, posing a safety risk. Furthermore, the insulation layer encounters the problem of melting insufficiency during the melting, resulting in a lack of electrical contact between the conductive layers on both sides, and weakening the current-carrying capacity of the electrode plate.

To improve the safety performance of the electrochemical device, this application provides an electrode assembly. The electrode assembly includes a first electrode plate and a second electrode plate of opposite polarities. The first electrode plate includes a first current collector, a first active material layer, a second active material layer, a first tab, and a second tab. The first current collector includes a first conductive layer, a first insulation layer, and a second conductive layer, the first conductive layer, the first insulation layer, and the second conductive layer are sequentially arranged along a thickness direction of the current collector. The first conductive layer includes a first surface facing away from the first insulation layer. The second conductive layer includes a second surface facing away from the first insulation layer. A first active material layer is disposed on the first surface, and a second active material layer is disposed on the second surface. The first current collector includes a first single-side blank foil region and a second single-side blank foil region. The first active material layer is provided with a first groove. A first surface in the first single-side blank foil region is exposed in the first groove. A second surface in the first single-side blank foil region is covered by the second active material layer. The second active material layer is provided with a second groove. The first surface in the second single-side blank foil region is covered by the first active material layer. The second surface in the second single-side blank foil region is exposed in the second groove. The first tab is at least partially accommodated in the first groove, and is bonded to the first single-side blank foil region by a first adhesive layer. The second tab is at least partially accommodated in the second groove, and is bonded to the second single-side blank foil region by a second adhesive layer. By bonding the first tab to the first conductive layer through the first adhesive layer and bonding the second tab to the second conductive layer through the second adhesive layer, this application makes it unnecessary to weld tabs, thereby reducing the safety hazards of the first current collector caused by weld imprint cracking. In an electrode assembly of this structure, the first electrode plate and the second electrode plate are of opposite polarities, so that metal ions can move between the first electrode plate and the second electrode plate to implement charging and discharging of the electrode assembly. The first current collector includes a first conductive layer, a first insulation layer, and a second conductive layer, the first conductive layer, the first insulation layer, and the second conductive layer are sequentially arranged along the thickness direction of the current collector. The first active material layer is disposed on the first surface of the first conductive layer. The second active material layer is disposed on the second surface of the second conductive layer. In this way, metal ions can be intercalated or deintercalated in the first active material layer and the second active material layer to implement movement of the metal ions. The first current collector includes a first single-side blank foil region and a second single-side blank foil region. The first surface in the first single-side blank foil region is bonded to the first tab. The second surface in the first single-side blank foil region is covered by the second active material layer. The first surface in the second single-side blank foil region is covered by the first active material layer. The second surface in the second single-side blank foil region is bonded to the second tab. Compared with a circumstance in which grooves are provided on the current collector on both the side connected to the tab and the side facing away from the tab, in this application, the first current collector is coated with the second active material layer on the side facing away from the first tab, and the first current collector is coated with the first active material layer on the side facing away from the second tab, thereby reducing the loss of active material, making the electrode assembly be coated with a relatively large amount of active material layer, and increasing the energy density of the electrochemical device formed by the electrode assembly. At the same time, the first current collector is a composite current collector. The first tab and the second tab are distributed on two sides of the first current collector respectively. The first tab is electrically connected to the first conductive layer. The second tab is electrically connected to the second conductive layer to facilitate output or input of electrical energy. The arrangement of the first tab and the second tab increases the number of tabs, and can improve the charge and discharge rates. The first tab is at least partially accommodated in the first groove, and the second tab is at least partially accommodated in the second groove, thereby not only facilitating connection between the first tab and the first current collector, and between the second tab and the first current collector, but also reducing the overall thickness of the electrode assembly, and increasing the energy density of an electrochemical device equipped with this electrode assembly. The first tab is bonded to the first conductive layer by the first adhesive layer, and the second tab is bonded to the second conductive layer by the second adhesive layer, thereby facilitating operation and reducing the difficulty of manufacturing. By bonding the first tab to the first conductive layer through the first adhesive layer and bonding the second tab to the second conductive layer through the second adhesive layer, this application makes it unnecessary to weld tabs, thereby reducing the safety hazards of the first current collector caused by weld imprint cracking.

An embodiment of this application provides an electrochemical device. The electrochemical device includes an electrode assembly. The electrochemical device may be a secondary battery or a primary battery. For example, the electrochemical device may be a lithium-ion battery, a sodium-ion battery, a magnesium-ion battery, or the like. The type of the electrochemical device is not limited herein. The electrochemical device may assume a shape such as a cylinder, a flat body, a cuboid, or another shape.

An embodiment of this application provides an electrical device that uses an electrochemical device as a power supply. The electrical device may be, but is not limited to, a mobile phone, a tablet, a laptop computer, an electrical toy, an electrical tool, an electric power cart, an electric vehicle, a ship, a spacecraft, or the like.

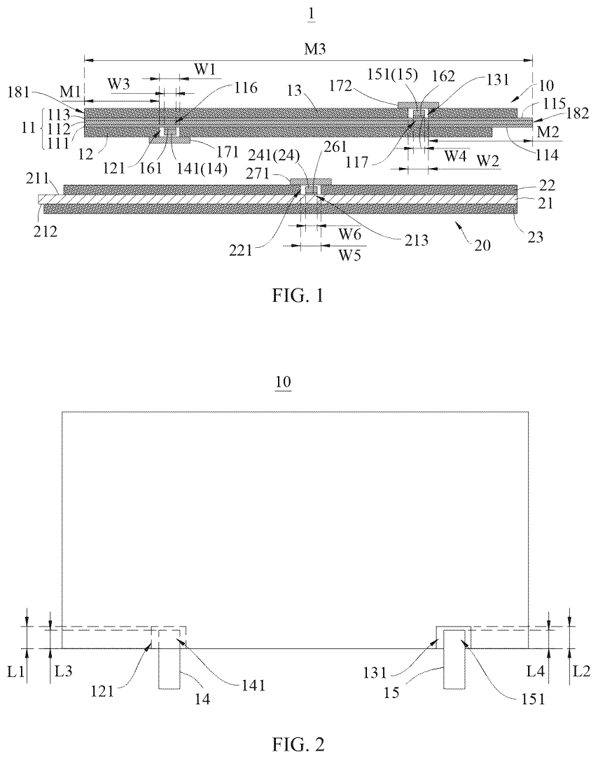

Referring to FIG. 1, FIG. 1 is a cross-sectional view of an electrode assembly according to some embodiments of this application, and FIG. 1 is a cross-sectional view of the electrode assembly in an unwound state.

An embodiment of this application provides an electrode assembly 1. The electrode assembly includes a first electrode plate 10 and a second electrode plate 20 of opposite polarities. The first electrode plate 10 includes a first current collector 11, a first active material layer 12, a second active material layer 13, a first tab 14, and a second tab 15. The first current collector 11 includes a first conductive layer 111, a first insulation layer 112, and a second conductive layer 113 that are sequentially arranged along a thickness direction of the current collector. The first conductive layer 111 includes a first surface 114 facing away from the first insulation layer 112. The second conductive layer 113 includes a second surface 115 facing away from the first insulation layer 112. The first active material layer 12 is disposed on the first surface 114, and the second active material layer 13 is disposed on the second surface 115. The first current collector 11 includes a first single-side blank foil region 116 and a second single-side blank foil region 117. The first active material layer 12 is provided with a first groove 121. The first surface 114 in the first single-side blank foil region 116 is exposed in the first groove 121. The second surface 115 in the first single-side blank foil region 116 is covered by the second active material layer 13. The second active material layer 13 is provided with a second groove 131. The first surface 114 in the second single-side blank foil region 117 is covered by the first active material layer 12. The second surface 115 in the second single-side blank foil region 117 is exposed in the second groove 131. The first tab 14 is at least partially accommodated in the first groove 121, and is bonded to the first single-side blank foil region 116 by a first adhesive layer 161. The first tab 14 is electrically connected to the first conductive layer 111. The second tab 15 is at least partially accommodated in the second groove 131, and is bonded to the second single-side blank foil region 117 by a second adhesive layer 162. The second tab 15 is electrically connected to the second conductive layer 113.

In some embodiments, the first surface 114 and the second surface 115 are two opposite surfaces of the first current collector 11 in the thickness direction of the first current collector 11. The first active material layer 12 and the second active material layer 13 are disposed on two sides of the first current collector 11 respectively. The first active material layer 12 is disposed on the first conductive layer 111, and the second active material layer 13 is disposed on the second conductive layer 113.

In some embodiments, the first single-side blank foil region 116 is a section of the first current collector 11, and includes the first surface 114 and the second surface 115. The second single-side blank foil region 117 is a section of the first current collector 11, and includes the first surface 114 and the second surface 115.

In some embodiments, the first current collector 11 is a composite current collector. The material of the first conductive layer 111 may be the same as that of the second conductive layer 113. The materials of the first conductive layer 111 and the second conductive layer 113 may be aluminum, copper, or the like. The first insulation layer 112 may be a polymer layer such as polypropylene or polyethylene terephthalate.

In some embodiments, the first groove 121 is a recessed structure provided in the first active material layer 12. Along the thickness direction of the first current collector 11, the first groove 121 penetrates the first active material layer 12. The first groove 121 extends to the first surface 114 from a surface of the first active material layer 12 on a side facing away from the first surface 114, so that the first surface 114 in the first single-side blank foil region 116 is exposed in the first groove 121. Similarly, the second groove 131 is a recessed structure provided in the second active material layer 13. Along the thickness direction of the first current collector 11, the second groove 131 penetrates the second active material layer 13. The second groove 131 extends to the second surface 115 from a surface of the second active material layer 13 on a side facing away from the second surface 115, so that the second surface 115 in the second single-side blank foil region 117 is exposed in the second groove 131.

In some embodiments, the first tab 14 and the second tab 15 are made of a metal material such as copper or aluminum.

In some embodiments, the material of the first adhesive layer 161 includes epoxy resin, polyurethane, polyethylene, polypropylene, or polyolefin.

In some embodiments, a part of the first tab 14 is accommodated in the first groove 121. This part of the first tab 14 is bonded to the first surface 114 in the first single-side blank foil region 116 by the first adhesive layer 161 to implement connection between the first tab 14 and the first conductive layer 111. The first tab 14 is electrically connected to the first conductive layer 111. For example, the first adhesive layer 161 may be made of an insulating material. Within the first groove 121, a part of the first tab 14 may be bonded to the first surface 114 by the first adhesive layer 161. A part of the first tab 14 may contact the first surface 114 to implement electrical connection between the first tab 14 and the first conductive layer 111. Alternatively, the first adhesive layer 161 may include a conductive material. The first tab 14 is bonded to the first surface 114 by the first adhesive layer 161. The first tab 14 may be electrically connected to the first surface 114 by the conductive material in the first adhesive layer 161. For example, the first adhesive layer 161 is a conductive adhesive.

In some embodiments, the material of the second adhesive layer 162 includes epoxy resin, polyurethane, polyethylene, polypropylene, or polyolefin.

In some embodiments, a part of the second tab 15 is accommodated in the second groove 131. This part of the second tab 15 is bonded to the second surface 115 in the second single-side blank foil region 117 by the second adhesive layer 162 to implement connection between the second tab 15 and the second conductive layer 113. The second tab 15 is electrically connected to the second conductive layer 113. For example, the second adhesive layer 162 may be made of an insulating material. Within the second groove 131, a part of the second tab 15 may be bonded to the second surface 115 by the second adhesive layer 162. A part of the second tab 15 may contact the second surface 115 to implement electrical connection between the second tab 15 and the second conductive layer 113. Alternatively, the second adhesive layer 162 may include a conductive material. The second tab 15 is bonded to the second surface 115 by the second adhesive layer 162. The second tab 15 may be electrically connected to the second surface 115 by the conductive material in the second adhesive layer 162. For example, the second adhesive layer 162 is a conductive adhesive.

In the above technical solution, the first electrode plate 10 and the second electrode plate 20 are of opposite polarities, so that metal ions can move between the first electrode plate 10 and the second electrode plate 20 to implement charging and discharging of the electrode assembly 1. The first current collector 11 includes a first conductive layer 111, a first insulation layer 112, and a second conductive layer 113 arranged sequentially along the thickness direction of the current collector. The first active material layer 12 is disposed on the first surface 114 of the first conductive layer 111. The second active material layer 13 is disposed on the second surface 115 of the second conductive layer 113. In this way, metal ions can be intercalated or deintercalated in the first active material layer 12 and the second active material layer 13 to implement movement of the metal ions. The first current collector 11 includes a first single-side blank foil region 116 and a second single-side blank foil region 117. The first surface 114 in the first single-side blank foil region 116 is bonded to the first tab 14. The second surface 115 in the first single-side blank foil region 116 is covered by the second active material layer 13. The first surface 114 in the second single-side blank foil region 117 is covered by the first active material layer 12. The second surface 115 in the second single-side blank foil region 117 is bonded to the second tab 15. Compared with a circumstance in which grooves are provided on the current collector on both the side connected to the tab and the side facing away from the tab, in this application, the first current collector 11 is coated with the second active material layer 13 on the side facing away from the first tab 14, and the first current collector 11 is coated with the first active material layer 12 on the side facing away from the second tab 15, thereby reducing the loss of active material, making the electrode assembly 1 be coated with a relatively large amount of active material layer, and increasing the energy density of the electrochemical device formed by the electrode assembly 1. At the same time, the first current collector 11 is a composite current collector. The first tab 14 and the second tab 15 are distributed on two sides of the first current collector 11 respectively. The first tab 14 is electrically connected to the first conductive layer 111. The second tab 15 is electrically connected to the second conductive layer 113 to facilitate output or input of electrical energy. The arrangement of the first tab 14 and the second tab 15 increases the number of tabs, and can improve the charge and discharge rates. The first tab 14 is at least partially accommodated in the first groove 121, and the second tab 15 is at least partially accommodated in the second groove 131, thereby not only facilitating connection between the first tab 14 and the first current collector 11, and between the second tab 15 and the first current collector 11, but also reducing the overall thickness of the electrode assembly 1, and increasing the energy density of an electrochemical device equipped with this electrode assembly 1. The first tab 14 is bonded to the first conductive layer 111 by the first adhesive layer 161, and the second tab 15 is bonded to the second conductive layer 113 by the second adhesive layer 162, thereby facilitating operation and reducing the difficulty of manufacturing. By bonding the first tab 14 to the first conductive layer 111 through the first adhesive layer 161 and bonding the second tab 15 to the second conductive layer 113 through the second adhesive layer 162, this application makes it unnecessary to weld tabs, thereby reducing the safety hazards of the first current collector 11 caused by weld imprint cracking.

In some embodiments, the electrode assembly 1 is a jelly-roll structure.

Referring to FIG. 1 together with FIG. 2, FIG. 2 is a schematic structural diagram of a first electrode plate according to some embodiments of this application.

In some embodiments, along the winding direction of the electrode assembly 1, the width W1 of the first groove 121 satisfies 5 mm≤W1≤15 mm. For example, W1 may be 5 mm, 6 mm, 7 mm, 8 mm, 9 mm, 10 mm, 11 mm, 12 mm, 13 mm, 14 mm, or 15 mm, or the like.

Along the winding axis direction of the electrode assembly 1, the length L1 of the first groove 121 satisfies 5 mm≤L1≤25 mm. For example, L1 may be 5 mm, 10 mm, 15 mm, 20 mm, 25 mm, or the like.

The width W1 of the first groove 121 is made to satisfy 5 mm≤W1≤15 mm along the winding direction of the electrode assembly 1, and the length L1 of the first groove 121 is made to satisfy 5 mm≤L1≤25 mm along the winding axis direction of the electrode assembly 1. On the one hand, this provides a relatively large connection area between the first current collector 11 and the first tab 14, thereby providing a relatively large current-carrying capacity between the first current collector 11 and the first tab 14. On the other hand, this reduces the volume loss of the first active material layer 12, thereby increasing the energy density of an electrochemical device equipped with this electrode assembly 1.

In some embodiments, along the winding direction of the electrode assembly 1, the width W2 of the second groove 131 satisfies 5 mm≤W2≤15 mm. For example, W2 may be 5 mm, 6 mm, 7 mm, 8 mm, 9 mm, 10 mm, 11 mm, 12 mm, 13 mm, 14 mm, or 15 mm, or the like.

Along the winding axis direction of the electrode assembly 1, the length L2 of the second groove 131 satisfies 5 mm≤L2≤25 mm. For example, L2 may be 5 mm, 10 mm, 15 mm, 20 mm, 25 mm, or the like.

The width W2 of the second groove 131 is made to satisfy 5 mm≤W2≤15 mm along the winding direction of the electrode assembly 1, and the length L2 of the second groove 131 is made to satisfy 5 mm≤L2≤25 mm along the winding axis direction of the electrode assembly 1. On the one hand, this provides a relatively large connection area between the first current collector 11 and the second tab 15, thereby providing a relatively large current-carrying capacity between the first current collector 11 and the second tab 15. On the other hand, this reduces the volume loss of the second active material layer 13, thereby increasing the energy density of an electrochemical device equipped with this electrode assembly 1.

Referring to FIG. 1 and FIG. 2, in some embodiments, the first tab 14 includes a first part 141 that overlaps the first current collector 11. When viewed along the thickness direction of the first current collector 11, the first part 141 is located within the first groove 121, and the first part 141 overlaps the first current collector 11.

In some embodiments, a thickness direction of the first part 141 is parallel to a thickness direction of the first current collector 11.

The thickness H1 of the first part 141 satisfies 20 μm≤H1≤120 μm. For example, H1 may be 20 μm, 30 μm, 40 μm, 50 μm, 60 μm, 70 μm, 80 μm, 90 μm, 100 μm, 110 μm, 120 μm, or the like.

Along the winding direction of the electrode assembly 1, the width W3 of the first part 141 satisfies 2 mm≤W3≤14 mm. For example, W3 may be 2 mm, 4 mm, 6 mm, 8 mm, 10 mm, 12 mm, 14 mm, or the like.

Along the winding axis direction of the electrode assembly 1, the length L3 of the first part 141 satisfies 2 mm≤L3≤24 mm. For example, L3 may be 2 mm, 4 mm, 6 mm, 8 mm, 10 mm, 12 mm, 14 mm, 16 mm, 18 mm, 20 mm, 22 mm, 24 mm, or the like.

The thickness H1 of the first part 141 is made to satisfy 20 μm≤H1≤120 μm. Along the winding direction of the electrode assembly 1, the width W3 of the first part 141 is made to satisfy 2 m≤W3≤14 mm. Along the winding axis direction of the electrode assembly 1, the length L3 of the first part 141 satisfies: 2 mm≤L3≤24 mm. On the one hand, this provides a relatively large connection area between the first tab 14 and the first current collector 11, thereby providing a relatively large current-carrying capacity between the first tab 14 and the first current collector. On the other hand, this enables a relatively small area of the first groove 121, and reduces the volume loss of the first active material layer 12, thereby increasing the energy density of an electrochemical device equipped with this electrode assembly 1.

In some embodiments, the second tab 15 includes a second part 151 that overlaps the first current collector 11. When viewed along the thickness direction of the first current collector 11, the second part 151 is located within the second groove 131, and the second part 151 overlaps the second current collector.

In some embodiments, a thickness direction of the second part 151 is parallel to a thickness direction of the first current collector 11.

The thickness H2 of the second part 151 satisfies 20 μm≤H2≤120 μm. For example, H2 may be 20 μm, 30 μm, 40 μm, 50 μm, 60 μm, 70 μm, 80 μm, 90 μm, 100 μm, 110 μm, 120 μm, or the like.

Along the winding direction of the electrode assembly 1, the width W4 of the second part 151 satisfies 2 mm≤W4≤14 mm. For example, W4 may be 2 mm, 4 mm, 6 mm, 8 mm, 10 mm, 12 mm, 14 mm, or the like.

Along the winding axis direction of the electrode assembly 1, the length L4 of the second part 151 satisfies 2 mm≤L4≤24 mm. For example, L4 may be 2 mm, 4 mm, 6 mm, 8 mm, 10 mm, 12 mm, 14 mm, 16 mm, 18 mm, 20 mm, 22 mm, 24 mm, or the like.

The thickness H2 of the second part 151 is made to satisfy 20 μm≤H2≤120 μm. Along the winding direction of the electrode assembly 1, the width W4 of the second part 151 is made to satisfy 2 mm≤W4≤14 mm. Along the winding axis direction of the electrode assembly 1, the length L4 of the second part 151 satisfies: 2 mm≤L4≤24 mm. On the one hand, this provides a relatively large connection area between the second tab 15 and the first current collector 11, thereby providing a relatively large current-carrying capacity between the second tab 15 and the first current collector. On the other hand, this enables a relatively small area of the second groove 131, and reduces the volume loss of the second active material layer 13, thereby increasing the energy density of an electrochemical device equipped with this electrode assembly 1.

In some embodiments, the electrode assembly 1 is a jelly-roll structure. The first electrode plate 10 includes a winding start end 181 and a winding termination end 182. The first electrode plate 10 is a continuous strip-shaped structure. Along the winding direction of the electrode assembly 1, the winding start end 181 means an end of the first electrode plate 10, the end being closest to the winding axis of the electrode assembly 1; and the winding termination end 182 means an end of the first electrode plate 10, the end being farthest away from the winding axis of the electrode assembly 1.

Along the winding direction of the electrode assembly 1, the first groove 121 is closer to the winding start end 181 than the second groove 131. Along the winding direction of the electrode assembly 1, a distance between the first groove 121 and the winding start end 181 is M1, a distance between the second groove 131 and the winding termination end 182 is M2, and a length of the first electrode plate 10 is M3, satisfying 0.25≤M1/M3≤0.35, and 0.25≤M2/M3≤0.35.

It is hereby noted that, for ease of description, the first electrode plate 10 in FIG. 1 is a schematic diagram in an unwound state, M1 is the distance between an end of the first groove 121, which is close to the winding start end 181, and the winding start end 181; M2 is a distance between an end of the second groove 131, which is close to the winding termination end 182, and the winding termination end 182; and M3 is a length of the first electrode plate 10 unwound.

When M1/M3 is relatively large, M1 is relatively large, and the distance between the first groove 121 and the second groove 131 is relatively small, thereby being prone to cause interference between the first groove 121 and the second groove 131. When M1/M3 is relatively small, M1 is relatively small, the distance between the first groove 121 and the winding start end 181 is relatively small, the distance between the second groove 131 and the winding termination end 182 is relatively small, and the distance between the first groove 121 and the second groove 131 is relatively large. Consequently, the current flow path in the middle in the winding direction toward the first tab and the second tab is relatively long, and the current output capability is relatively low.

Along the winding direction of the electrode assembly 1, with the distance between the first groove 121 and the winding start end being M1, the distance between the second groove 131 and the winding termination end being M2, and the length of the first electrode plate 10 being M3, by making the parameter relationships satisfy 0.25≤M1/M3≤0.35 and 0.25≤M2/M3≤0.35, on the one hand, this facilitates processing and manufacturing, and reduces the risk of interference between the first groove and the second groove; on the other hand, this facilitates the flow of current between the first current collector and the first and second tabs, and facilitates the output and input of electrical energy, thereby improving the charging and discharging efficiency.

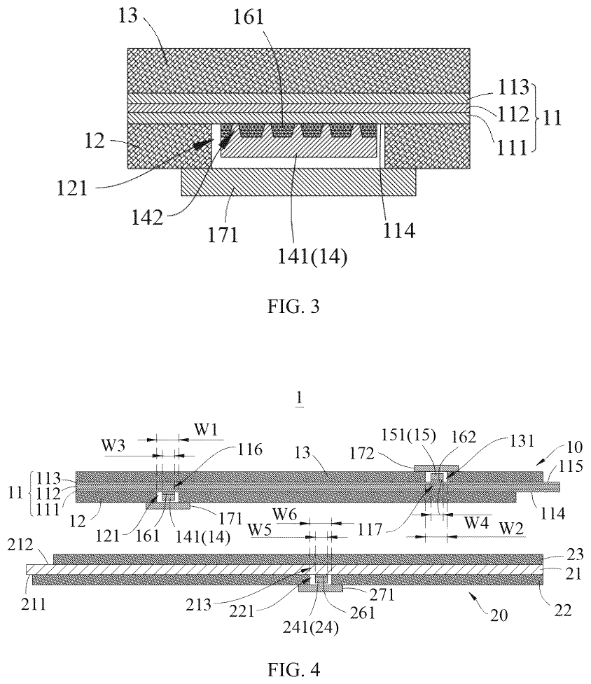

Refer to FIG. 3, FIG. 3 is a schematic assembly diagram of a plurality of first bulges and a first conductive layer according to some embodiments of this application, and FIG. 3 is a cross-sectional view of a partial structure of the first electrode plate. In some embodiments, a plurality of first bulges 142 are formed on one side of the first tab 14, the side facing the first current collector 11; and at least a part of the plurality of first bulges 142 are in contact with the first conductive layer 111.

At a junction between the first tab 14 and the first current collector 11, the first tab 14 includes a fifth surface facing the first current collector 11, and a first bulge 142 is formed on one side of the first tab 14, the side facing the first current collector 11. The first bulge 142 protrudes toward the first current collector 11, so that the first tab 14 contacts the first conductive layer 111 through the first bulge 142, thereby implementing electrical connection between the first tab 14 and the first current collector 11.

In some embodiments, a plurality of first bulges 142 are distributed in a matrix to facilitate manufacturing.

In some embodiments, the first tab 14 may be processed by stamping, laser, cold heading, etching, or the like to form the first bulge 142.

In some embodiments, the shape of the first bulge 142 may be diverse. For example, the first bulge 142 may be a cylinder, a cone, a polygonal prism, or the like.

In some embodiments, a first adhesive layer 161 may be provided and accommodated between two adjacent first bulges 142. To assemble the first tab 14 and the first conductive layer 111, the first adhesive layer 161 may be first applied on the fifth surface of the first tab 14, and then the first tab 14 coated with the first adhesive layer 161 is bonded to the first conductive layer 111. The first adhesive layer 161 is activated by hot pressing, thereby implementing the bonding and fixation between the first tab 14 and the first current collector 11. The plurality of first bulges 142 are spaced apart. A region between adjacent first bulges 142 can accommodate the first adhesive. The first bulges 142 are in contact with the first conductive layer 111. The first adhesive bonds the fifth surface and the first surface 114, thereby implementing electrical connect between the first tab 14 and the first conductive layer 111 while implementing bonding between the first tab 14 and the first current collector 11.

By forming a plurality of first bulges 142 on the first tab 14 on the side facing the first current collector 11, this application facilitates the positioning of the first tab 14 relative to the first adhesive layer 161. The first adhesive layer 161 can be accommodated in a region between two adjacent first bulges 142, so as to improve the bonding effect between the first tab 14 and the first conductive layer 111. At least a part of the plurality of first bulges 142 are in contact with the first conductive layer 111, so as to implement electrical connection between the first tab 14 and the first conductive layer 111.

In some embodiments, a plurality of second bulges (not shown in the figure) are formed on one side of the second tab 15, the side facing the first current collector 11; and at least a part of the plurality of second bulges are in contact with the second conductive layer 113.

For the arrangement of the second bulges, reference may be made to the arrangement of the first bulges 142.

By forming a plurality of second bulges on the second tab 15 on the side facing the first current collector 11, this application facilitates the positioning of the second tab 15 relative to the second adhesive layer 162. The second adhesive layer 162 can be accommodated in a region between two adjacent second bulges, so as to improve the bonding effect between the second tab 15 and the second conductive layer 113. At least a part of the plurality of second bulges are in contact with the second conductive layer 113, so as to implement electrical connection between the second tab 15 and the second conductive layer 113.

Referring to FIG. 1 and FIG. 3, in some embodiments, the first electrode plate 10 further includes a first insulation piece 171. The first insulation piece 171 is disposed on one side of the first tab 14 and covers the first tab 14, the side facing away from the first current collector 11.

In some embodiments, the first insulation piece 171 may be adhesive tape, which is simple in structure and facilitates positioning of the first insulation piece 171.

In some embodiments, the first insulation piece 171 may be sheet-shaped. The thickness direction of the first insulation piece 171 is parallel to the thickness direction of the first current collector 11.

In some embodiments, the first insulation piece 171 may be bonded to the first active material layer 12. When viewed along the thickness direction of the first current collector 11, the first insulation piece 171 covers the first groove 121. On the one hand, this facilitates the assembling and positioning of the first insulation piece 171; on the other hand, this enables the first insulation piece 171 to cover the first tab 14.

The first insulation piece 171 covers the first tab 14 so that the first insulation piece 171 can play a role in insulating the first tab 14 from the second electrode plate 20, thereby reducing the probability of contact circuiting between the first electrode plate 10 and the second electrode plate 20. In view of the burrs on the surface of the first tab 14, the first insulation piece 171 can also isolate the burrs, and make the burrs less prone to contact the second electrode plate 20 and consequently cause a short circuit or damage the second electrode plate 20.

In some embodiments, the first electrode plate 10 further includes a second insulation piece 172. The second insulation piece 172 is disposed on one side of the second tab 15 and covers the second tab 15, the side facing away from the first current collector 11.

In some embodiments, the second insulation piece 172 may be adhesive tape, which is simple in structure and facilitates positioning of the second insulation piece 172.

In some embodiments, the second insulation piece 172 may be sheet-shaped. The thickness direction of the second insulation piece 172 is parallel to the thickness direction of the first insulation piece 171.

In some embodiments, the second insulation piece 172 may be bonded to the second active material layer 13. When viewed along the thickness direction of the first current collector 11, the second insulation piece 172 covers the second groove 131. On the one hand, this facilitates the assembling and positioning of the second insulation piece 172; on the other hand, this enables the second insulation piece 172 to cover the second tab 15.

The second insulation piece 172 covers the second tab 15 so that the second insulation piece 172 can play a role in insulating the second tab 15 from the second electrode plate 20, thereby reducing the probability of contact circuiting between the first electrode plate 10 and the second electrode plate 20. In view of the burrs on the surface of the second tab 15, the second insulation piece 172 can also isolate the burrs, and make the burrs less prone to contact the second electrode plate 20 and consequently cause a short circuit or damage the second electrode plate 20.

Referring to FIG. 1 and FIG. 4, FIG. 4 is a cross-sectional view of an electrode assembly according to other embodiments of this application, and FIG. 4 is a cross-sectional view of the electrode assembly in an unwound state. In some embodiments, the second electrode plate 20 includes a second current collector 21, a third active material layer 22, a fourth active material layer 23, and a third tab 24. The second current collector 21 includes a third surface 211 and a fourth surface 212 disposed opposite to each other. The second current collector 21 includes a third single-side blank foil region 213. The third active material layer 22 is disposed on the third surface 211. The third active material layer 22 is provided with a third groove 221. The third surface 211 in the third single-side blank foil region 213 is exposed in the third groove 221. The fourth active material layer 23 is disposed on the fourth surface 212. The fourth surface 212 in the third single-side blank foil region 213 is covered by the fourth active material layer 23. The third tab 24 is at least partially accommodated in the third groove 221, and is bonded to the third single-side blank foil region 213 by a third adhesive layer 261. The third tab 24 is electrically connected to the third single-side blank foil region 213.

In some embodiments, the third surface 211 and the fourth surface 212 are two opposite surfaces of the second current collector 21 in the thickness direction of the second current collector 21. The third active material layer 22 and the fourth active material layer 23 are disposed on two sides of the second current collector 21 respectively.

In some embodiments, the third single-side blank foil region 213 is a section of the second current collector 21, and includes the third surface 211 and the fourth surface 212.

In some embodiments, the second current collector 21 may be made of a material such as aluminum, copper, or the like.

In some embodiments, the third groove 221 is a recessed structure provided in the third active material layer 22. Along the thickness direction of the second current collector 21, the third groove 221 penetrates the third active material layer 22. The third groove 221 extends to the third surface 211 from a surface of the third active material layer 22 on a side facing away from the third surface 211, so that the third surface 211 in the third single-side blank foil region 213 is exposed in the third groove 221.

In some embodiments, the material of the third adhesive layer 261 includes epoxy resin, polyurethane, polyethylene, polypropylene, or polyolefin.

In some embodiments, a part of the third tab 24 is accommodated in the third groove 221. This part of the third tab 24 is bonded to the third surface 211 in the third single-side blank foil region 213 by the third adhesive layer 261 to implement connection between the third tab 24 and the second current collector 21. For example, the third adhesive layer 261 may be made of an insulating material. Within the third groove 221, a part of the third tab 24 may be bonded to the third surface 211 by the third adhesive layer 261. A part of the third tab 24 may contact the third surface 211 to implement electrical connection between the third tab 24 and the second current collector 21. Alternatively, the third adhesive layer 261 may include a conductive material. The third tab 24 is bonded to the third surface 211 by the third adhesive layer 261. The third tab 24 may be electrically connected to the third surface 211 by the conductive material in the third adhesive layer 261. For example, the third adhesive layer 261 is a conductive adhesive.

In some embodiments, referring to FIG. 1, the third surface 211 may be a surface of the second current collector 21, the surface facing the first active material layer 12; or, referring to FIG. 4, the third surface 211 may be a surface of the second current collector 21, the surface facing away from the first active material layer 12.

In the above technical solution, the third active material layer 22 is disposed on the third surface 211, and the fourth active material layer 23 is disposed on the fourth surface 212, thereby enabling metal ions to be intercalated in and deintercalated out of the third active material layer 22 and the fourth active material layer 23, thereby enabling movement of the metal ions. The second current collector 21 includes a third single-side blank foil region 213. The third surface 211 in the third single-side blank foil region 213 is bonded to the third tab 24. The fourth surface 212 in the third single-side blank foil region 213 is covered by the fourth active material layer 23. Compared with a circumstance in which grooves are provided on the current collector on both the side connected to the tab and the side facing away from the tab, in this application, the second current collector 21 is coated with the fourth active material layer 23 on the side facing away from the third tab 24, thereby reducing the loss of active material, making the electrode assembly 1 be coated with a relatively large amount of active material layer, and increasing the energy density of the electrochemical device formed by the electrode assembly 1. The third tab 24 is at least partially accommodated in the third groove 221, thereby not only facilitating connection between the third tab 24 and the second current collector 21, but also reducing the overall thickness of the electrode assembly 1, and increasing the energy density of the electrochemical device equipped with this electrode assembly 1. The third tab 24 is bonded to the third single-side blank foil region 213 by the third adhesive layer 261, thereby facilitating operation and reducing the difficulty of manufacturing.

Referring to FIG. 1 and FIG. 4, in some embodiments, the second electrode plate 20 further includes a third insulation piece 271. The third insulation piece 271 is disposed on one side of the third tab 24 and covers the third tab 24, the side facing away from the second current collector 21.

In some embodiments, the third insulation piece 271 may be adhesive tape, which is simple in structure and facilitates positioning of the third insulation piece 271.

In some embodiments, the third insulation piece 271 may be sheet-shaped. The thickness direction of the third insulation piece 271 is parallel to the thickness direction of the second current collector 21.

In some embodiments, the third insulation piece 271 may be bonded to the third active material layer 22. When viewed along the thickness direction of the second current collector 21, the third insulation piece 271 covers the third groove 221. On the one hand, this facilitates the assembling and positioning of the third insulation piece 271; on the other hand, this enables the third insulation piece 271 to cover the third tab 24.

The third insulation piece 271 covers the third tab 24 so that the third insulation piece 271 can play a role in insulating the third tab 24 from the first electrode plate 10, thereby reducing the probability of contact circuiting between the second electrode plate 20 and the first electrode plate 10. In view of the burrs on the surface of the third tab 24, the third insulation piece 271 can also isolate the burrs, and make the burrs less prone to contact the first electrode plate 10 and consequently cause a short circuit or damage the first electrode plate 10.

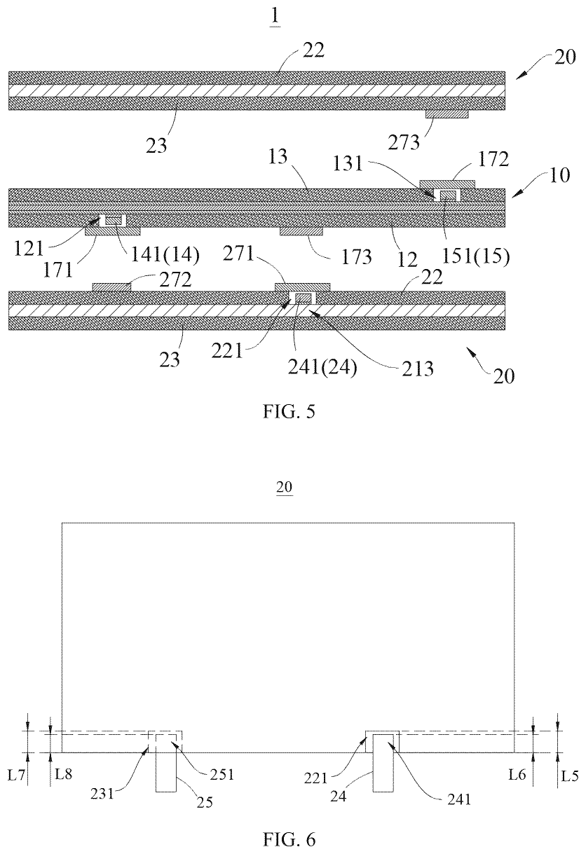

Referring to FIG. 5, FIG. 5 is a cross-sectional view of an electrode assembly according to other embodiments of this application, and FIG. 5 is a schematic structural diagram of a part of the electrode assembly sectioned in a wound state. In some embodiments, the first electrode plate 10 further includes a fourth insulation piece 173. The fourth insulation piece 173 is disposed on the first active material layer 12. When viewed along the thickness direction of the first current collector 11, a projection of the fourth insulation piece 173 covers the third tab 24.

In some embodiments, the fourth insulation piece 173 may be adhesive tape. The fourth insulation piece 173 can be bonded to the first active material layer 12, and is simple in structure and facilitates positioning of the fourth insulation piece 173.

In some embodiments, the fourth insulation piece 173 may be sheet-shaped. The thickness direction of the fourth insulation piece 173 is parallel to the thickness direction of the first current collector 11.

In some embodiments, when viewed along the thickness direction of the first current collector 11, the fourth insulation piece 173 is arranged corresponding to the third tab 24. For example, the projection of the fourth insulation piece 173 may fall into the third groove 221, thereby allowing a relatively small thickness of the electrode assembly 1, and enabling a relatively high energy density of the electrochemical device equipped with this electrode assembly 1. For another example, the projection of the fourth insulation piece 173 may cover the third groove 221. When viewed along the thickness direction of the first current collector 11, the fourth insulation piece 173 and the second electrode plate 20 overlap in a relatively large area.

By making the projection of the fourth insulation piece 173 cover the third tab 24 when viewed along the thickness direction of the first current collector 11, the fourth insulation piece 173 is enabled to isolate the burrs of the third tab 24, thereby making the burrs less prone to contact the first active material layer 12 and consequently cause a short circuit or damage the first electrode plate 10.

Referring to FIG. 5, in some embodiments, the second electrode plate 20 further includes a fifth insulation piece 272. The fifth insulation piece 272 is disposed on the third active material layer 22. When viewed along the thickness direction of the second current collector 21, a projection of the fifth insulation piece 272 covers the first tab 14.

In some embodiments, the fifth insulation piece 272 may be adhesive tape. The fifth insulation piece 272 can be bonded to the third active material layer 22, and is simple in structure and facilitates positioning of the fifth insulation piece 272.

In some embodiments, the fifth insulation piece 272 may be sheet-shaped. The thickness direction of the fifth insulation piece 272 is parallel to the thickness direction of the second current collector 21.

In some embodiments, when viewed along the thickness direction of the second current collector 21, the fifth insulation piece 272 is arranged corresponding to the first tab 14. For example, the projection of the fifth insulation piece 272 may fall into the first groove 121, thereby allowing a relatively small thickness of the electrode assembly 1, and enabling a relatively high energy density of the electrochemical device equipped with this electrode assembly 1. For another example, the projection of the fifth insulation piece 272 may cover the first groove 121. When viewed along the thickness direction of the second current collector 21, the fifth insulation piece 272 and the first electrode plate 10 overlap in a relatively large area.

By making the projection of the fifth insulation piece 272 cover the first tab 14 when viewed along the thickness direction of the second current collector 21, the fifth insulation piece 272 is enabled to isolate the burrs of the first tab 14, thereby further making the burrs less prone to contact the second active material layer 13 and consequently cause a short circuit or damage the second electrode plate 20.

In some embodiments, the second electrode plate 20 further includes a sixth insulation piece 273. The sixth insulation piece 273 is disposed on the fourth active material layer 23. When viewed along the thickness direction of the second current collector 21, a projection of the sixth insulation piece 273 covers the second tab 15.

In some embodiments, the sixth insulation piece 273 may be adhesive tape. The sixth insulation piece 273 can be bonded to the fourth active material layer 23, and is simple in structure and facilitates positioning of the sixth insulation piece 273.

In some embodiments, the sixth insulation piece 273 may be sheet-shaped. The thickness direction of the sixth insulation piece 273 is parallel to the thickness direction of the second current collector 21.

In some embodiments, when viewed along the thickness direction of the second current collector 21, the sixth insulation piece 273 is arranged corresponding to the second tab 15. For example, the projection of the sixth insulation piece 273 may fall into the second groove 131, thereby allowing a relatively small thickness of the electrode assembly 1, and enabling a relatively high energy density of the electrochemical device equipped with this electrode assembly 1. For another example, the projection of the sixth insulation piece 273 may cover the second groove 131. When viewed along the thickness direction of the second current collector 21, the sixth insulation piece 273 and the first electrode plate 10 overlap in a relatively large area.

By making the projection of the sixth insulation piece 273 cover the second tab 15 when viewed along the thickness direction of the second current collector 21, the sixth insulation piece 273 is enabled to isolate the burrs of the second tab 15, thereby further making the burrs less prone to contact the second active material layer 13 and consequently cause a short circuit or damage the second electrode plate 20.

Referring to FIG. 1 and FIG. 4 together with FIG. 6, FIG. 6 is a schematic structural diagram of a second electrode plate according to some embodiments of this application.

In some embodiments, along the winding direction of the electrode assembly 1, the width W5 of the third groove 221 satisfies 5 mm≤W5≤15 mm. For example, W5 may be 5 mm, 6 mm, 7 mm, 8 mm, 9 mm, 10 mm, 11 mm, 12 mm, 13 mm, 14 mm, 15 mm, or the like.

In some embodiments, along the winding axis direction of the electrode assembly 1, the length L5 of the third groove 221 satisfies 5 mm≤L5≤25 mm. For example, L5 may be 5 mm, 10 mm, 15 mm, 20 mm, 25 mm, or the like.

The width W5 of the third groove 221 is made to satisfy 5 mm≤W5≤15 mm along the winding direction of the electrode assembly 1, and the length L5 of the third groove 221 is made to satisfy 5 mm≤L5≤25 mm along the winding axis direction of the electrode assembly 1. On the one hand, this provides a relatively large connection area between the second current collector 21 and the third tab 24, thereby providing a relatively large current-carrying capacity between the second current collector 21 and the third tab 24. On the other hand, this reduces the volume loss of the third active material layer 22, thereby increasing the energy density of an electrochemical device equipped with this electrode assembly 1.

In some embodiments, the third tab 24 includes a third part 241 connected to the third single-side blank foil region 213. When viewed along the thickness direction of the second current collector 21, the third part 241 is located within the third groove 221, and the third part 241 overlaps the second current collector 21.

In some embodiments, a thickness direction of the third part 241 is parallel to a thickness direction of the second current collector 21.

The thickness H3 of the third part 241 satisfies 20 μm≤H3≤120 μm. For example, H3 may be 20 μm, 30 μm, 40 μm, 50 μm, 60 μm, 70 μm, 80 μm, 90 μm, 100 μm, 110 μm, 120 μm, or the like.

Along the winding direction of the electrode assembly 1, the width W6 of the third part 241 satisfies 2 mm≤W6≤14 mm. For example, W6 may be 2 mm, 4 mm, 6 mm, 8 mm, 10 mm, 12 mm, 14 mm, or the like.

Along the winding axis direction of the electrode assembly 1, the length L6 of the third part 241 satisfies 2 mm≤L6≤24 mm. For example, L6 may be 2 mm, 4 mm, 6 mm, 8 mm, 10 mm, 12 mm, 14 mm, 16 mm, 18 mm, 20 mm, 22 mm, 24 mm, or the like.

The thickness H3 of the third part 241 is made to satisfy 20 μm≤H3≤120 μm. Along the winding direction of the electrode assembly 1, the width W6 of the third part 241 satisfies 2 mm≤W6≤14 mm. Along the winding axis direction of the electrode assembly 1, the length L6 of the third part 241 is made to satisfy 2 mm≤L6≤24 mm. On the one hand, this provides a relatively large connection area between the third tab 24 and the second current collector 21, thereby providing a relatively large current-carrying capacity between the third tab 24 and the second current collector. On the other hand, this enables a relatively small area of the third groove 221, and reduces the volume loss of the third active material layer 22, thereby increasing the energy density of an electrochemical device equipped with this electrode assembly 1.

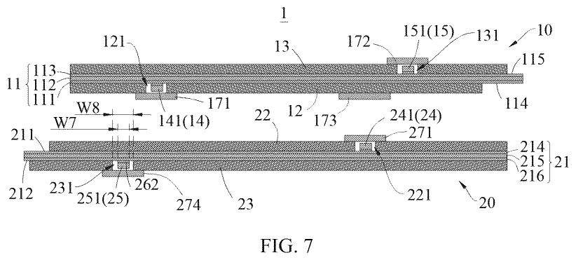

Referring to FIG. 7, FIG. 7 is a cross-sectional view of an electrode assembly according to still other embodiments of this application, and FIG. 7 is a cross-sectional view of the electrode assembly in an unwound state. In some embodiments, the second current collector 21 includes a third conductive layer 214, a second insulation layer 215, and a fourth conductive layer 216 that are sequentially arranged along a thickness direction of the current collector. The third surface 211 is a surface of the third conductive layer 214, the side facing away from the second insulation layer 215. The fourth surface 212 is a surface of the fourth conductive layer 216, the fourth surface 216 facing away from the second insulation layer 215. The second current collector 21 further includes a fourth single-side blank foil region 217. The fourth active material layer 23 is provided with a fourth groove 231. The third surface 211 in the fourth single-side blank foil region 217 is covered by the third active material layer 22. The fourth surface 212 in the fourth single-side blank foil region 217 is exposed in the fourth groove 231. The second electrode plate 20 further includes a fourth tab 25. The fourth tab 25 is at least partially accommodated in the fourth groove 231, and is bonded to the fourth single-side blank foil region 217 by a fourth adhesive layer 262. The third tab 24 is electrically connected to the third conductive layer 214. The fourth tab 25 is electrically connected to the fourth conductive layer 216.

In some embodiments, the second current collector 21 is a composite current collector. The material of the third conductive layer 214 may be the same as that of the fourth conductive layer 216. The materials of the third conductive layer 214 and the fourth conductive layer 216 may be aluminum, copper, or the like. The second insulation layer 215 may be a polymer layer such as polypropylene or polyethylene terephthalate.

In some embodiments, the third surface 211 may be a surface of the second current collector 21, the surface facing the first active material layer 12, and the fourth surface 212 may be a surface of the second current collector 21, the surface facing away from the first active material layer 12. Alternatively, the third surface 211 may be a surface of the second current collector 21, the surface facing away from the first active material layer 12; and the fourth surface 212 may be a surface of the second current collector 21, the surface facing the first active material layer 12.

In some embodiments, the fourth single-side blank foil region 217 is a section of the second current collector 21, and includes the third surface 211 and the fourth surface 212.

In some embodiments, the fourth groove 231 is a recessed structure provided in the fourth active material layer 23. Along the thickness direction of the second current collector 21, the fourth groove 231 penetrates the fourth active material layer 23. The fourth groove 231 extends to the fourth surface 212 from a surface of the fourth active material layer 23 on a side facing away from the fourth surface 212, so that the fourth surface 212 in the fourth single-side blank foil region 217 is exposed in the fourth groove 231.

In some embodiments, the material of the fourth adhesive layer 262 includes epoxy resin, polyurethane, polyethylene, polypropylene, or polyolefin.

In some embodiments, a part of the fourth tab 25 is accommodated in the fourth groove 231. This part of the fourth tab 25 is bonded to the fourth surface 212 in the fourth single-side blank foil region 217 by the fourth adhesive layer 262 to implement connection between the fourth tab 25 and the second current collector 21. The fourth tab 25 is electrically connected to the second current collector 21. For example, the fourth adhesive layer 262 may be made of an insulating material. Within the fourth groove 231, a part of the fourth tab 25 may be bonded to the fourth surface 212 by the fourth adhesive layer 262. A part of the fourth tab 25 may contact the fourth surface 212 to implement electrical connection between the fourth tab 25 and the second current collector 21. Alternatively, the fourth adhesive layer 262 may include a conductive material. The fourth tab 25 is bonded to the fourth surface 212 by the fourth adhesive layer 262. The fourth tab 25 may be electrically connected to the fourth surface 212 by the conductive material in the fourth adhesive layer 262. For example, the fourth adhesive layer 262 is a conductive adhesive.

In the above technical solution, the second current collector 21 is a composite current collector. The third tab 24 and the fourth tab 25 are distributed on two sides of the first current collector 11 respectively. The third tab 24 is electrically connected to the third conductive layer 214, and the fourth tab 25 is electrically connected to the fourth conductive layer 216, thereby facilitating output and input of electrical energy. The third tab 24 and the fourth tab 25 disposed increase the number of tabs, and improve the charge and discharge rates. The fourth tab 25 is at least partially accommodated in the fourth groove 231, thereby not only facilitating connection between the fourth tab 25 and the second current collector 21, but also reducing the overall thickness of the electrode assembly 1, and increasing the energy density of the electrochemical device equipped with this electrode assembly 1. The fourth tab 25 is bonded to the fourth single-side blank foil region 217 by the fourth adhesive layer 262, thereby facilitating operation and reducing the difficulty of manufacturing.

Referring to FIG. 7, the second electrode plate further includes a seventh insulation piece 274. The seventh insulation piece 274 is disposed on one side of the fourth tab 25 and covers the fourth tab 25, the side facing away from the second current collector 21.

The seventh insulation piece 274 covers the fourth tab 25 so that the seventh insulation piece 274 can play a role in insulating the fourth tab 25 from the first electrode plate 10, thereby reducing the probability of contact circuiting between the second electrode plate 20 and the first electrode plate 10. In view of the burrs on the surface of the fourth tab 25, the seventh insulation piece 274 can also isolate the burrs, and make the burrs less prone to contact the first electrode plate 10 and consequently cause a short circuit or damage the first electrode plate 10.

Referring to FIG. 6 and FIG. 7, in some embodiments, along the winding direction of the electrode assembly 1, the width of the fourth groove 231 is W7, satisfying: 5 mm≤W7≤15 mm. For example, W7 may be 5 mm, 6 mm, 7 mm, 8 mm, 9 mm, 10 mm, 11 mm, 12 mm, 13 mm, 14 mm, 15 mm, or the like.

In some embodiments, along the winding axis direction of the electrode assembly 1, the length of the fourth groove 231 is L7, satisfying: 5 mm≤L7≤25 mm. For example, L7 may be 5 mm, 10 mm, 15 mm, 20 mm, 25 mm, or the like.

The width W7 of the fourth groove 231 is made to satisfy 5 mm≤W7≤15 mm along the winding direction of the electrode assembly 1, and the length L7 of the fourth groove 231 is made to satisfy 5 mm≤L7≤25 mm along the winding axis direction of the electrode assembly 1. On the one hand, this provides a relatively large connection area between the second current collector 21 and the fourth tab 25, thereby providing a relatively large current-carrying capacity between the second current collector 21 and the fourth tab 25. On the other hand, this reduces the volume loss of the fourth active material layer 23, thereby increasing the energy density of an electrochemical device equipped with this electrode assembly 1.

In some embodiments, the fourth tab 25 includes a fourth part 251 connected to the fourth single-side blank foil region 217. When viewed along the thickness direction of the second current collector 21, the fourth part 251 is located within the fourth groove 231, and the fourth part 251 overlaps the second current collector 21.

In some embodiments, a thickness direction of the fourth part 251 is parallel to a thickness direction of the second current collector 21.

The thickness of the fourth part 251 is H8, satisfying: 20 μm≤H 8≤120 μm. For example, H8 may be 20 μm, 30 μm, 40 μm, 50 μm, 60 μm, 70 μm, 80 μm, 90 μm, 100 μm, 110 μm, 120 μm, or the like.

Along the winding direction of the electrode assembly 1, the width of the fourth part 251 is W8, satisfying: 2 mm≤W8≤14 mm. For example, W8 may be 2 mm, 4 mm, 6 mm, 8 mm, 10 mm, 12 mm, 14 mm, or the like.

Along the winding axis direction of the electrode assembly 1, the length of the fourth part 251 is L8, satisfying: 2 mm≤L8≤24 mm. For example, L8 may be 2 mm, 4 mm, 6 mm, 8 mm, 10 mm, 12 mm, 14 mm, 16 mm, 18 mm, 20 mm, 22 mm, 24 mm, or the like.

The thickness H8 of the fourth part 251 is made to satisfy 20 μm≤H8≤120 μm. Along the winding direction of the electrode assembly 1, the width W8 of the fourth part 251 satisfies 2 mm≤W8≤14 mm. Along the winding axis direction of the electrode assembly 1, the length L8 of the fourth part 251 is made to satisfy 2 mm≤L8≤24 mm. On the one hand, this provides a relatively large connection area between the fourth tab 25 and the second current collector 21, thereby providing a relatively large current-carrying capacity between the fourth tab 25 and the second current collector. On the other hand, this enables a relatively small area of the fourth groove 231, and reduces the volume loss of the fourth active material layer 23, thereby increasing the energy density of an electrochemical device equipped with this electrode assembly 1.

In some embodiments, thicknesses of the first conductive layer 111, the second conductive layer 113, the third conductive layer 214, and the fourth conductive layer 216 are all 0.2 μm to 3 μm. The thicknesses of the conductive layers are greater than 0.2 μm, so that the conductive layers are of relatively high conductivity. The thicknesses are less than 3 μm, ensuring that the energy density of the battery is not significantly lost. In addition, due to the insulation layer in the middle of the composite current collector, a conductive layer needs to be disposed on the insulation layer by means of vapor deposition, and the thickness needs to be relatively small.

In some embodiments, the first electrode plate 10 is a positive electrode plate, and the second electrode plate 20 is a negative electrode plate.

The first electrode plate 10 is a positive electrode plate, and the first tab 14 and the second tab 15 are positive tabs. Compared with a single positive tab, the two-positive-tab structure of this application can reduce the internal resistance of the electrochemical device, increase the charge and discharge speed, and reduce the temperature rise caused by charging.

Referring to FIG. 1, an embodiment of this application provides an electrode assembly 1. The electrode assembly includes a first electrode plate 10 and a second electrode plate 20 of opposite polarities. The first electrode plate 10 includes a first current collector 11, a first active material layer 12, a second active material layer 13, a first tab 14, a second tab 15, a first insulation piece 171, and a second insulation piece 172. The first current collector 11 includes a first conductive layer 111, a first insulation layer 112, and a second conductive layer 113 that are sequentially arranged along a thickness direction of the current collector. The first conductive layer 111 includes a first surface 114 facing away from the first insulation layer 112. The second conductive layer 113 includes a second surface 115 facing away from the first insulation layer 112. The first active material layer 12 is disposed on the first surface 114, and the second active material layer 13 is disposed on the second surface 115. The first current collector 11 includes a first single-side blank foil region 116 and a second single-side blank foil region 117. The first active material layer 12 is provided with a first groove 121. The first surface 114 in the first single-side blank foil region 116 is exposed in the first groove 121. The second surface 115 in the first single-side blank foil region 116 is covered by the second active material layer 13. The second active material layer 13 is provided with a second groove 131. The first surface 114 in the second single-side blank foil region 117 is covered by the first active material layer 12. The second surface 115 in the second single-side blank foil region 117 is exposed in the second groove 131. The first tab 14 is at least partially accommodated in the first groove 121, and is bonded to the first single-side blank foil region 116 by a first adhesive layer 161. The second tab 15 is at least partially accommodated in the second groove 131, and is bonded to the second single-side blank foil region 117 by a second adhesive layer 162. The first insulation piece 171 is disposed on one side of the first tab 14 and covers the first tab 14, the side facing away from the first current collector 11. The second insulation piece 172 is disposed on one side of the second tab 15 and covers the second tab 15, the side facing away from the first current collector 11.

The second electrode plate 20 includes a second current collector 21, a third active material layer 22, a fourth active material layer 23, a third tab 24, and a third insulation piece 271. The second current collector 21 includes a third surface 211 and a fourth surface 212 disposed opposite to each other. The second current collector 21 includes a third single-side blank foil region 213. The third active material layer 22 is disposed on the third surface 211. The third active material layer 22 is provided with a third groove 221. The third surface 211 in the third single-side blank foil region 213 is exposed in the third groove 221. The fourth active material layer 23 is disposed on the fourth surface 212. The fourth surface 212 in the third single-side blank foil region 213 is covered by the fourth active material layer 23. The third tab 24 is at least partially accommodated in the third groove 221, and is bonded to the third single-side blank foil region 213 by a third adhesive layer 261. The third insulation piece 271 is disposed on one side of the third tab 24 and covers the third tab 24, the side facing away from the second current collector 21.

This application further provides an electrochemical device. The electrochemical device includes the electrode assembly 1 provided in any one of the above embodiments.

This application further provides an electrical device. The electrical device includes the electrochemical device provided in the above embodiment. The electrochemical device is configured to provide electrical energy.

The electrical device may be any one of the above-mentioned devices or systems in which the electrochemical device is applied.

Although this application has been described with reference to preferred embodiments, various improvements may be made to the embodiments without departing from the scope of this application, and some components described in the embodiments may be replaced with equivalents. Particularly, to the extent that no structural conflict exists, various technical features mentioned in different embodiments may be combined in any manner. This application is not limited to the specific embodiments disclosed herein, but includes all technical solutions falling within the scope of the claims.

What is claimed is:

1. An electrode assembly, wherein, the electrode assembly comprises a first electrode plate and a second electrode plate of opposite polarities, and the first electrode plate comprises:
a first current collector, comprising a first conductive layer, a first insulation layer, and a second conductive layer; the first conductive layer, the first insulation layer, and the second conductive layer are sequentially arranged along a thickness direction of the current collector, wherein the first conductive layer comprises a first surface facing away from the first insulation layer, and the second conductive layer comprises a second surface facing away from the first insulation layer;
a first active material layer disposed on the first surface;
a second active material layer disposed on the second surface;
wherein, the first current collector comprises a first single-side blank foil region and a second single-side blank foil region;
the first active material layer is provided with a first groove, the first surface in the first single-side blank foil region is exposed in the first groove, and the second surface in the first single-side blank foil region is covered by the second active material layer;
the second active material layer is provided with a second groove, the first surface in the second single-side blank foil region is covered by the first active material layer, and the second surface in the second single-side blank foil region is exposed in the second groove;
the first electrode plate further comprises:
a first tab, at least partially accommodated in the first groove, and bonded to the first single-side blank foil region by a first adhesive layer, wherein the first tab is electrically connected to the first conductive layer;
a second tab, at least partially accommodated in the second groove, and bonded to the second single-side blank foil region by a second adhesive layer, wherein the second tab is electrically connected to the second conductive layer.

2. The electrode assembly according to claim 1, wherein, the electrode assembly is a jelly-roll structure;
along a winding direction of the electrode assembly, a width of the first groove is W1; and along a winding axis direction of the electrode assembly, a length of the first groove is L1, satisfying: 5 mm≤W1≤15 mm, and 5 mm≤L1≤25 mm.

3. The electrode assembly according to claim 1, wherein, the electrode assembly is a jelly-roll structure;
along a winding direction of the electrode assembly, a width of the second groove is W2, and along a winding axis direction of the electrode assembly, a length of the second groove is L2, satisfying: 5 mm≤W2≤15 mm, and 5 mm≤L2≤25 mm.

4. The electrode assembly according to claim 1, wherein, the electrode assembly is a jelly-roll structure; and
the first tab comprises a first part, the first part overlaps the first current collector, a thickness of the first part is H1; along a winding direction of the electrode assembly, a width of the first part is W3; and along a winding axis direction of the electrode assembly, a length of the first part is L3, satisfying: 2 mm≤W3≤14 mm, 2 mm≤L3≤24 mm, and 20 μm≤H1≤120 μm.

5. The electrode assembly according to claim 1, wherein, the electrode assembly is a jelly-roll structure; and
the second tab comprises a second part, the second part overlaps the first current collector, a thickness of the second part is H2; along a winding direction of the electrode assembly, a width of the second part is W4; and along a winding axis direction of the electrode assembly, a length of the second part is L4, satisfying: 2 mm≤W4≤14 mm, and 2 mm≤L4≤24 mm, and 20 μm≤H2≤120 μm.

6. The electrode assembly according to claim 1, wherein, the electrode assembly is a jelly-roll structure;
the first electrode plate comprises a winding start end and a winding termination end; along a winding direction of the electrode assembly, the first groove is closer to the winding start end than the second groove; and
along the winding direction of the electrode assembly, a distance between the first groove and the winding start end is M1, a distance between the second groove and the winding termination end is M2, and a length of the first electrode plate is M3, satisfying 0.25≤M1/M3≤0.35, and 0.25≤M2/M3≤0.35.

7. The electrode assembly according to claim 1, wherein, a plurality of first bulges are formed on one side of the first tab, the side facing the first current collector; and at least a part of the plurality of first bulges are in contact with the first conductive layer.

8. The electrode assembly according to claim 1, wherein, the first electrode plate further comprises:
a first insulation piece disposed on one side of the first tab and covering the first tab, the one side of the first tab facing away from the first current collector; and
a second insulation piece disposed on one side of the second tab and covering the second tab, the one side of the second tab facing away from the first current collector.

9. The electrode assembly according to claim 1, wherein, the second electrode plate comprises:
a second current collector, comprising a third surface and a fourth surface disposed opposite to each other, wherein the second current collector comprises a third single-side blank foil region;
a third active material layer disposed on the third surface, wherein the third active material layer is provided with a third groove, and the third surface in the third single-side blank foil region is exposed in the third groove;
a fourth active material layer disposed on the fourth surface, wherein the fourth surface in the third single-side blank foil region is covered by the fourth active material layer; and
a third tab, at least partially accommodated in the third groove, and bonded to the third single-side blank foil region by a third adhesive layer, wherein the third tab is electrically connected to the second current collector.

10. The electrode assembly according to claim 9, wherein, the second current collector comprises a third conductive layer, a second insulation layer, and a fourth conductive layer; the third conductive layer, the second insulation layer, and the fourth conductive layer are sequentially arranged along a thickness direction of the second current collector; the third surface is a surface of the third conductive layer facing away from the second insulation layer;
the fourth surface is a surface of the fourth conductive layer facing away from the second insulation layer; and the second current collector further comprises a fourth single-side blank foil region;
the fourth active material layer is provided with a fourth groove, the third surface in the fourth single-side blank foil region is covered by the third active material layer, and the fourth surface in the fourth single-side blank foil region is exposed in the fourth groove; and
the second electrode plate further comprises:
a fourth tab, at least partially accommodated in the fourth groove, and bonded to the fourth single-side blank foil region by a fourth adhesive layer, wherein the third tab is electrically connected to the third conductive layer, and the fourth tab is electrically connected to the fourth conductive layer.

11. The electrode assembly according to claim 10, wherein, at least one of the first adhesive layer, the second adhesive layer, the third adhesive layer, or the fourth adhesive layer is a conductive adhesive.

12. The electrode assembly according to claim 10, wherein, thicknesses of the first conductive layer, the second conductive layer, the third conductive layer, and the fourth conductive layer are in a range of 0.2 μm to 3 μm.

13. The electrode assembly according to claim 9, wherein, the second electrode plate further comprises:
a third insulation piece, disposed on one side of the third tab and covering the third tab, the one side of the third tab facing away from the second current collector.

14. The electrode assembly according to claim 9, wherein, the first electrode plate further comprises:
a fourth insulation piece disposed on the first active material layer; wherein, when viewed along a thickness direction of the first current collector, a projection of the fourth insulation piece covers the third tab.

15. The electrode assembly according to claim 9, wherein, the second electrode plate further comprises:
a fifth insulation piece disposed on the third active material layer; wherein, when viewed along a thickness direction of the second current collector, a projection of the fifth insulation piece covers the first tab; and
a sixth insulation piece disposed on the fourth active material layer; and when viewed along a thickness direction of the second current collector, a projection of the sixth insulation piece covers the second tab.

16. The electrode assembly according to claim 9, wherein, the electrode assembly is a jelly-roll structure; and
along a winding direction of the electrode assembly, a width of the third groove is W5, and along a winding axis direction of the electrode assembly, a length of the third groove is L5, satisfying: 5 mm≤W5≤15 mm, and 5 mm≤L5≤25 mm.

17. The electrode assembly according to claim 9, wherein, the electrode assembly is a jelly-roll structure; and
the third tab comprises a third part connected to the third single-side blank foil region, a thickness of the third part is H3; along a winding direction of the electrode assembly, a width of the third part is W6; along a winding axis direction of the electrode assembly, a length of the third part is L6, satisfying: 2 mm≤W6≤14 mm, and 2 mm≤L6≤24 mm, and 20 μm≤H3≤120 μm.

18. The electrode assembly according to claim 1, wherein, the first electrode plate is a positive electrode plate, and the second electrode plate is a negative electrode plate.

19. An electrochemical device, wherein, the electrochemical device comprises the electrode assembly as claimed in claim 1.

20. An electrical device, wherein, the electrical device comprises the electrochemical device according to claim 19, and the electrochemical device is configured to provide electrical energy.
